(19) United States
(12) Patent Application Publication
(10) Pub. No.: US 2002/0107830 A1
(43) Pub. Date: Aug. 8, 2002

(54) Aggregating web data on clients and distributing the aggregated data to wireless handheld device

(76) Inventor: Murthi Nanja, Portland, OR (US)

Correspondence Address: TROP PRUNER & HU, PC, 8554 KATY FREEWAY, SUITE 100, HOUSTON, TX, 77024, US

(21) Appl. No.: 09/778,565

(22) Filed: Feb. 7, 2001

(51) Int. Cl. G06F 7/00

(52) U.S. Cl. 707/1

(57) ABSTRACT

Data from two or more web sites may be aggregated on a local processor-based system. The aggregated data may then be forwarded to a wireless device. In this way, the aggregated data may be communicated to the wireless device in a single connection session.

### BACKGROUND

This invention relates in general to aggregation and distribution of web data.

Anyone with an Internet connection can access up-to-date information for stocks, news, sports, weather, etc. from millions of web sites. The information can be static information such as company product brochures or dynamic information such as stock quotes and weather. Today Internet users worldwide access information through their desktop personal computers, for example, using either their dial-up modem connections at home or their local area network connections at work.

Typically, information downloaded from a web site to a web browser is in HyperText Markup Language (HTML). When a user accesses a web site, the web browser first downloads the HTML contents to the user's local system, then processes the downloaded HTML document, and finally displays the web content to the user. In addition to the web browser, any other applications running on the local system can process and display HTML pages. Common Gateway Interface (CGI) scripts and middleware components running on the web server are commonly used to generate either static or dynamic HTML content. Users may access web content via wireless handheld devices such as Personal Digital Assistants (PDAs), web tablets, and cellular telephones as well as desktop or laptop computers.

Many wireless operators are currently providing wireless Internet access for handheld devices through second-generation (2G) cellular networks such as GSM (Global System for Mobile Communication), IS-95 CDMA (Code Division Multiple Access), IS-136 TDMA (Time Division Multiple Access), and PDC (Packetized Digital Cellular). These 2G cellular wireless networks provide data rates between 9.6 Kbps and 14.4 Kbps. Most of these 2G cellular technologies are based on circuit-switched operations.

Since the wireless handheld device subscribers are charged on the basis of connection time, wireless data services are expensive when compared to those of similar wireline Internet access services. Because of the costs involved, many handheld device owners are reluctant to use wireless Internet access, and only use their handheld device to synchronize Personal Information Management (PIM) software.

Wireless handheld device users may access information from individual web sites by accessing target Uniform Resource Locators (URLs) directly from their wireless handheld units connected to the Internet via a cellular network. Alternatively, users may access target URLs indirectly by synchronizing their device with their desktop system which acts as a proxy for the target URLs. In the second method, the desktop system can cache all predefined web pages for the handheld unit. Each time the user wants to access information from a different web page, a new session may be established, incurring increasing cellular charges.

Thus, there is a need for better ways to access information on the Internet using wireless devices.

### BRIEF DESCRIPTION OF THE DRAWINGS

FIG. 1 is a block diagram of a web data aggregation and distribution system in accordance with one embodiment of the present invention;

FIG. 2 depicts software components used in the data aggregation and distribution system in accordance with one embodiment of the present invention;

FIG. 3 depicts the data aggregation method employed by the data aggregator application in accordance with one embodiment of the present invention; and

FIG. 4 is a flow chart for software in accordance with one embodiment of the present invention.

### DETAILED DESCRIPTION

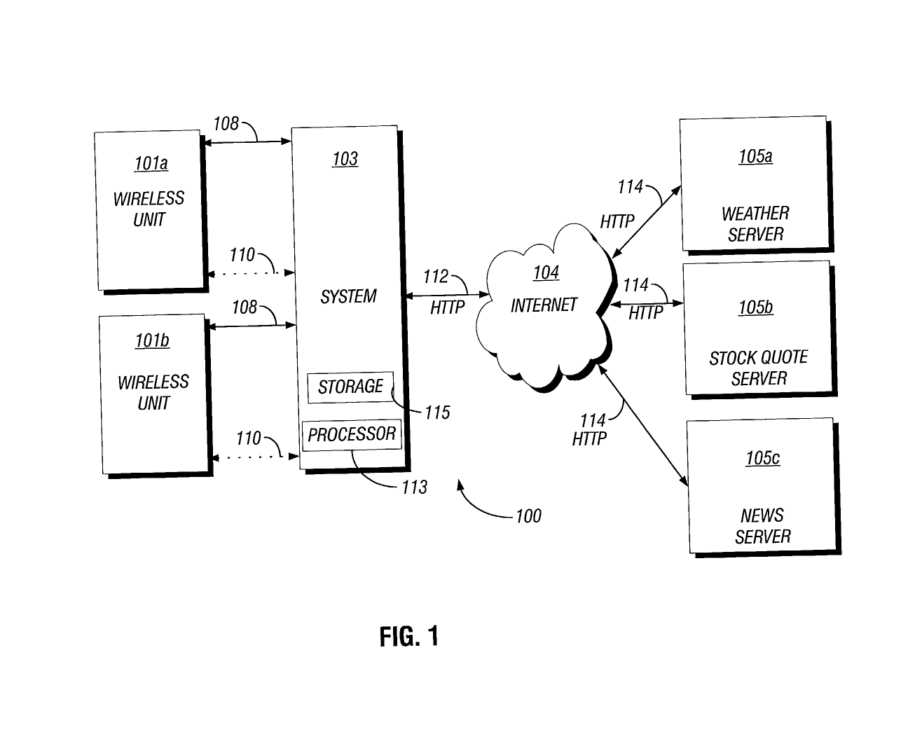

The data aggregation and distribution system 100, shown in FIG. 1, includes wireless units 101, processor-based system 103, Internet 104, and web servers 105. Buses 108 and 110 may be serial ports or Universal Serial Bus (USB) based cable or wireless interfaces between the wireless units 101, and the system 103, respectively. Hypertext Transfer protocol (HTTP) 112 and 114 are the protocol interfaces between the system 103 and the web servers 105, respectively. In the illustrated embodiment, three sample web servers, 105a, b and c (i.e., weather, stock quote and news) are depicted, but the nature of the information from the web servers can be anything relevant to mobile users (e.g., product price quotes and product inventory level from suppliers).

Wireless interfaces 110, such as Bluetooth wireless interfaces, may be located between the wireless units 101 and the system 103. The Internet 104 couples the system 103 and the web servers 105. The Bluetooth wireless interface is a short-range (within 10 meters) radio communication technology developed specifically as a cable replacement solution for desktop systems with standard peripherals such as keyboards, mice, printers, and digital cameras. In addition, Bluetooth has capabilities to set up point-to-point or point-to-multipoint ad hoc networks among many Bluetooth devices (e.g., desktop systems and PDAs).

The wireless units 101 can be handheld, mobile devices in one embodiment, such as PDAs, cellular telephones, or web tablets, or they may be other processor-based non-handheld, non-mobile devices. Each wireless unit 101 has cellular wireless connectivity and a HTML web browser. The system 103, acting as an intermediary or as an “information hub” for the wireless unit 101, provides aggregated web information to each wireless unit 101. The system 103 may be any processor-based system including a desktop computer or processor-based appliance, as two examples. The system 103 may include a processor 113 and storage 115 coupled to the processor 113. The web servers 105 act as information sources for the system 103. In one embodiment, no modifications or additional components, either hardware or software, may be needed on any of the components depicted in FIG. 1 other than the system 103.

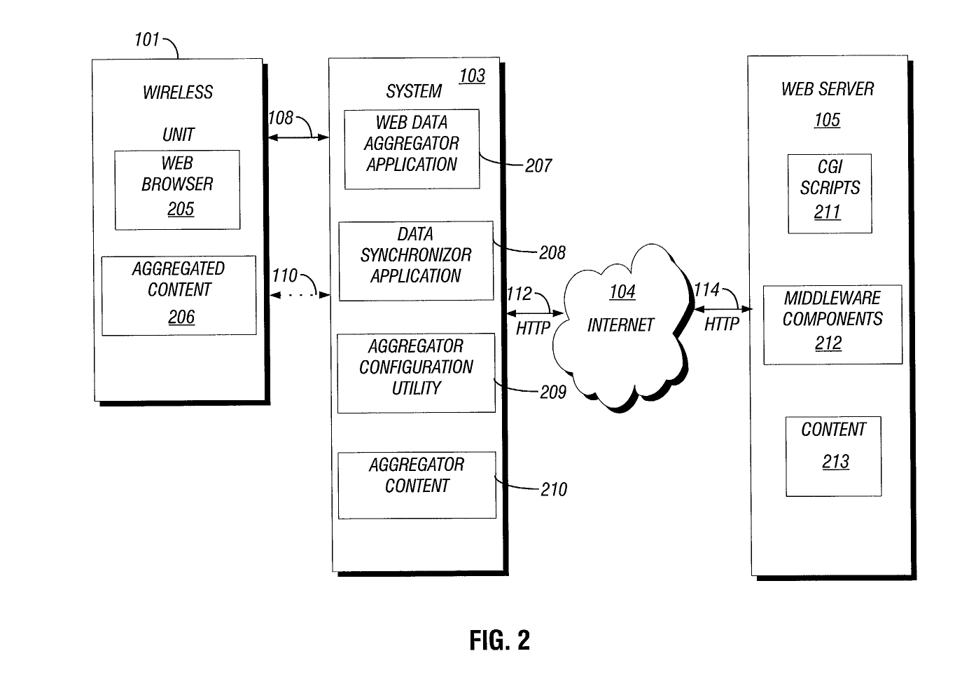

As shown in FIG. 2, a web data aggregator application 207, running on the system 103, performs integration or aggregation of various types of information relevant to each unit 101 user. The web aggregator application 207 is responsible for interacting with a web server 105, extracting desired information such as weather, stock quotes and news, and then aggregating this information in a manner that is meaningful to users of the wireless units 101. The applications 207-209 and the content 210 may be stored in the storage 115.

The web server 105 processes the HTTP requests 112/114 received from the system 103 using CGI scripts 211 and then sends a response as a HTTP response 114/112 to the system 103. The CGI scripts 211 access the target web content 213 directly or through middleware software component 212 and generate data, for example, in eXtensible Markup Language (XML) format in one embodiment. As an example, stock portfolio data gathered on the web server 105 in XML format may include information such as ticker, time, last price, open price, day's high, day's low, volume and average volume.

The web data aggregator application 207 gathers data (such as a stock portfolio) for various kinds of information in one embodiment. The web data aggregator application 207 may use Application Programming Interfaces (APIs) published by the web content vendors for their services in one embodiment. Using the APIs may reduce the need to retrieve HTML documents from the web server 105, parsing them to obtain user requested web data, and making the requested data available for aggregation. In addition, in one embodiment, the data aggregator application 207 may be unaltered, even if the format of the target web server 105 content is changed by the content vendor. Once the web data aggregator application 207 completes the task of gathering data from various web servers 105, in one embodiment, it may process the data using one or more XML Stylesheet Languages (XSL) to generate the aggregated content 210.

A data synchronizer application 208 running on the system 103 transfers the aggregated content 210 to a wireless unit 101. Data synchronization can be triggered by connecting a wireless unit 101 to the system 103 via interfaces 108/110. Alternatively, synchronization may be triggered by explicitly invoking a special command in the data synchronizer application 208, if the wireless handheld unit 101 is already connected to the system 103. By default, the data synchronizer application 208 transfers the aggregated content 210 to the wireless handheld unit 101 whenever there is a new information in the aggregated content 210. The user may configure the data synchronizer application 208 to modify the default data synchronization behavior.

A data aggregator configuration utility 209 running on the system 103 changes the data aggregator application's 207 behavior. By default, the data aggregator application 207 may attempt to gather web data at a predetermined time of the day set by the user. However, this can be changed by the data aggregator configuration utility 209, under the direct control of the user, to gather data whenever the system 103 is in idle state or based on some other user-specified criteria.

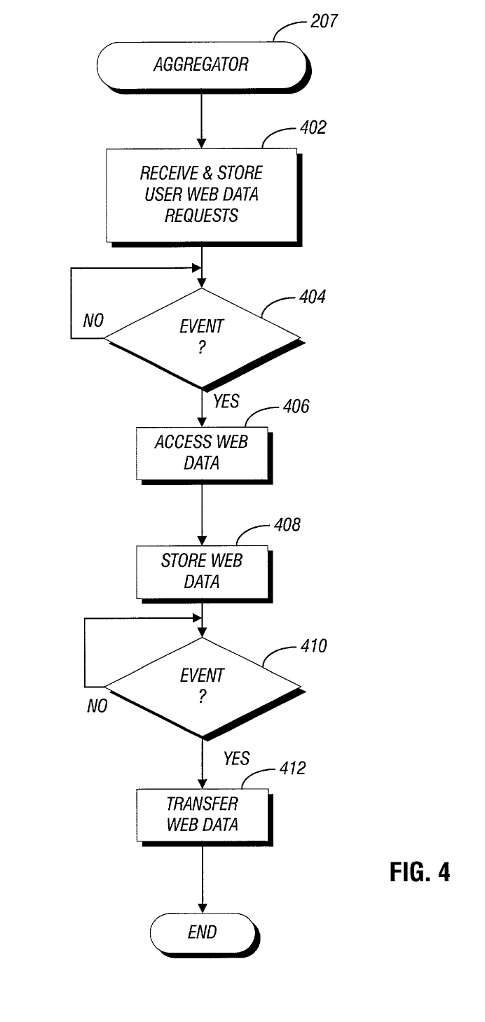

The data aggregator application 207, data aggregator configuration utility 209, and the data synchronizer application 208 may be combined into a single executable application on the system 103. In an embodiment in which the web data aggregator application 207 also includes the functions of the application 208 and utility 209, the application 207 receives and stores user web data requests as indicated in block 402 of FIG. 4. Upon the occurrence of an appropriate event, such as a period of low activity on the system 103, as indicated in diamond 404, the requested web data is automatically accessed over the Internet as indicated in block 406. The accessed web data is then stored as indicated in block 408.

Upon the occurrence of a predetermined event, such as a predetermined time or a user request from a wireless unit 101, as indicated in block 410, the accumulated web data is transferred from the system 103 to the unit 101 as indicated in block 412.

The wireless unit 101 has an Internet web browser 205 that is capable of displaying standard Internet content formats such as HTML and XML. The web browser 205 running on the wireless unit 101 may be used to browse the aggregated content 206 downloaded to the wireless unit 101.

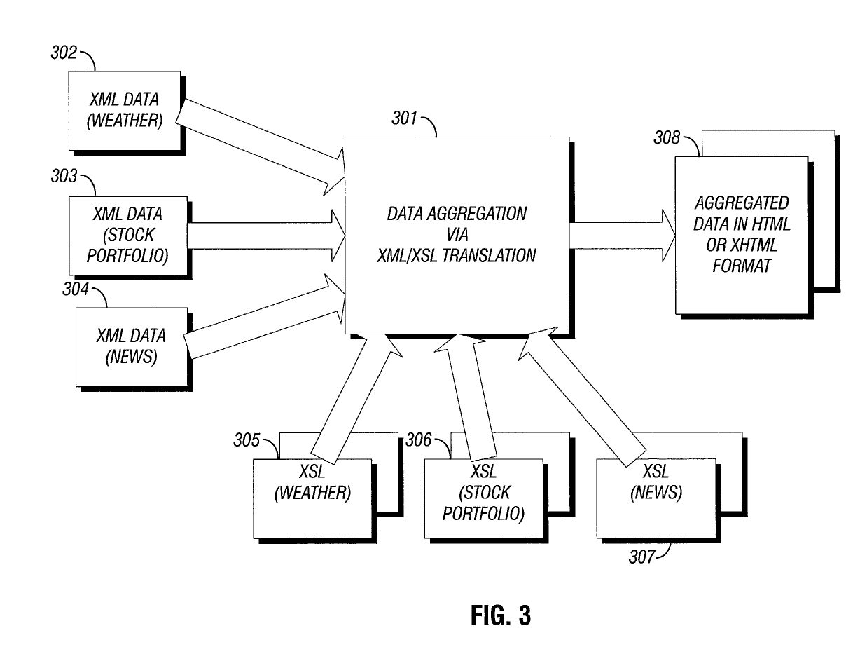

In one embodiment, the data aggregation method 301 takes XML data files 302, 303 and 304 generated from their respective web servers 105 and one or more XSL stylesheets 305, 306 and 307 for each type of web data information, as shown in FIG. 3. An XSL stylesheet describes how the XML source content should be styled, laid out and paginated onto a web browser 205 running on the wireless unit 101.

The data aggregation method 301 may accept both XML and XSL documents. The method may accept both XML and XSL for the handheld units 101 as aggregated data in HTML or extensible HTML (XHTML) format. The data aggregation method 301 can generate aggregated content in formats other than the default HTML or XHTML format by simply adding additional stylesheets.

The aggregated data in HTML format 308 may be represented as a single HTML file or a group of hyperlinked HTML files as two examples. Typically these files may be located in a single directory on the system 103 so that the data synchronizer application 208 can easily transfer them to the user's wireless unit 101.

The following example illustrates one embodiment of the application of the principles described herein.

1. A mobile user, who owns a system 103 at his/her office and a wireless unit 101, walks into his/her office at 8:00 in the morning, plugs in the unit 101 into a cradle that is attached to the system 103, and then powers up the system 103.

2. During the system boot-up sequence, the system 103 automatically runs the data aggregator application 207, the data synchronizer application 208, and the data aggregator configuration utility 209. These software components are configured during set up to automatically launch immediately after the system power-up.

3. The standard synchronizer agent for the unit 101 automatically transfers the mobile user's calendar, e-mails, contact information, and other related information to the handheld unit 101 so that this information is readily available to the mobile user when he/she is temporarily away from the office.

4. The mobile user performs routine tasks such as reading or sending e-mails, accessing Internet or intranet web sites, developing code, writing documents, and so on.

5. At the end of the day, around 5:30, the data aggregator application 207 automatically initiates the aggregation process and generates new aggregated content from various predefined web servers. This data aggregation activity is transparent to the mobile user.

6. Through the data synchronizer application 207, the mobile user transfers the new aggregated content to his/her wireless unit 101 before leaving the office for the day.

7. The mobile user leaves the office with his/her unit 101.

8. The mobile user browses the aggregated content using the web browser 205 at home.

Although the above usage scenario is intended for a corporate mobile user, the present invention is not so limited. The underlying principles can be easily applied to aggregate and distribute data in a consumer home environment or any other scenario.

Many existing wireless data services that are based on second generation (2G) wireless technologies are expensive when compared to those of similar wireline Internet data services. As a result, many mobile handheld device owners may prefer to view the aggregated data in offline mode rather than directly connecting to the Internet. In some embodiments of the present invention, a mechanism addresses this user preference issue. Some embodiments may provide a way to aggregate data on a user's local system 103 and then display the data on one or more units 101.

Some embodiments may have advantages over aggregating data on the web server 105, including reducing the wireless unit 101 owner's Internet connection time charges as information is aggregated and distributed using his/her system 103, providing opportunities for customizing aggregated data based on the wireless unit 101 owner's preferences, and providing a default view of the aggregated data to the unit 101 owner, if required. Aggregation of data from various web sites on a system 103, for example, may provide a unified view of information to the unit 101 owner and thereby increase his/her productivity. A wireless unit 101 owner may determine when to aggregate and distribute relevant web data on his/her system 103.

In some implementations, no changes or modifications may be needed to the wireless units 101 and no special software or hardware component needs to be installed on wireless units 101. Instead, the system 103 may alone accomplish the aggregation in one embodiment.

In one embodiment, data may be aggregated whenever the system 103 is in an idle state. In addition, the local user can configure the system 103 to aggregate data at a predetermined time of the day using a configuration utility 209.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
aggregating information form two or more web sites; and
providing said information to a wireless device.

2. The method of claim 1 including aggregating the information from two or more web sites on a processor-based system connectable to the wireless device.

3. The method of claim 1 including receiving user requests for information from web sites and storing said information received from web sites.

4. The method of claim 2 including establishing a telephone connection and during that connection, accessing the requested information from at least one web site.

5. The method claim 4 including accessing information from at least two web sites using a single connection.

6. The method of claim 1 including aggregating said information in response to the detection of an event.

7. The method of claim 6 including detecting a period of low activity on said system.

8. The method of claim 6 including detecting a predetermined time.

9. The method of claim 1 including storing aggregated information from two or more web sites and monitoring for an event.

10. The method of claim 9 including providing said information to a wireless device in response to monitoring the occurrence of an event.

11. The method of claim 10 including detecting the occurrence of a predetermined time and automatically transferring information to a wireless device at the predetermined time.

12. An article comprising a medium storing instructions that enable a processor-based system to:
aggregate information from two or more web sites; and
provide the information to a wireless device.

13. The article of claim 12 further storing instructions that enable the processor-based system to aggregate the information from two or more web sites for transmission to the wireless device.

14. The article of claim 12 further storing instructions that enable the processor-based system to receive user requests for information from web sites and store the information received from web sites.

15. The article of claim 13 further storing instructions that enable the processor-based system to establish a telephone connection and, during that connection, access the requested information from at least one web site.

16. The article of claim 15 further storing instructions that enable the processor-based system to access data from at least two web sites using a single connection.

17. The article of claim 12 further storing instructions that enable the processor-based system to aggregate the information in response to the detection of an event.

18. The article of claim 17 further storing instructions that enable the processor-based system to detect a period of low activity on said system.

19. The article of claim 17 further storing instructions that enable the processor-based system to detect a predetermined time.

20. The article of claim 12 further storing instructions that enable the processor-based system to store aggregated information from two or more web sites and monitor for an event.

21. The article of claim 20 further storing instructions that enable the processor-based system to provide the information to a wireless device in response to monitoring the occurrence of an event.

22. The article of claim 21 further storing instructions that enable the processor-based system to detect the occurrence of a predetermined time and automatically transfer web information to a wireless device at the predetermined time.

23. A system comprising:
a processor; and
a storage coupled to said processor, the storage storing instructions that enable the processor to aggregate information from two or more web sites and provide the information to a wireless device.

24. The system of claim 23 including a wireless connection connectable to the wireless device.

25. The system of claim 23 including an Internet connection.
